(19) United States
(12) Patent Application Publication
(10) Pub. No.: US 2012/0273069 A1
(43) Pub. Date: Nov. 1, 2012

(54) Water Damage Prevention System

(76) Inventors: Michael Klicpera, San Diego, CA (US); David Llorente, Santa Fe, TX (US)

(21) Appl. No.: 13/541,819

(22) Filed: Jul. 5, 2012

Related U.S. Application Data
(63) Continuation-in-part of application No. 11/877,860, filed on Oct. 24, 2007.
Application No. 11/877,860 is a continuation-in-part of application No. 12/539,150, filed on Aug. 11, 2009.
Application No. 12/539,150 is a continuation-in-part of application No. 12/877,094, filed on Sep. 7, 2010.
Application No. 12/877,094 is a continuation-in-part of application No. 12/956,031, filed on Nov. 30, 2010.
Application No. 12/956,031 is a continuation-in-part of application No. 13/216,497, filed on Aug. 24, 2011.

(51) Int. Cl. E03B 7/09

(52) U.S. Cl. 137/551; 137/624.11

(57) ABSTRACT

The present invention is a water damage prevention system that has a residential or industrial/commercial facility water supply interruption system. The system is comprised of a remotely controllable base station with shut-off/on mechanism that is in wireless or wired communication with a convenient controller. The base station with shut-off/on mechanism is interposed within a water line from a water main to the living or operating quarters portion of a residential or a industrial/commercial facility or building, such that activation of the base station with shut-off/on valve operates to prevent flow of water from the water main to the living quarters when the residential home or industrial/commercial facility or building is vacated or unsupervised. In this manner, damage to the living quarters or the industrial/commercial facility or building from failure of water pipes running through the living or working quarters is prevented during times that the shut-off mechanism is activated.

### RELATED APPLICATIONS

This application is a continuation-in-part of U.S. patent application Ser. No. 11/877,860 filed on Oct. 24, 2007, U.S. patent application Ser No. 12/539,150 filed on Aug. 11, 2009, U.S. patent application Ser. No. 12/877,094 filed on Sep. 7, 2010, U.S. patent application Ser. No. 12/956,031 filed on Nov. 11, 2010, U.S. patent application Ser. No. 13/216,497 filed on Aug. 24, 2011 and U.S. patent application Ser. No. 13/21,521 filed on Aug. 24, 2011. All of these Applications are incorporated herein by this reference.

### FIELD OF THE INVENTION

This apparatus and the method of use relates to water supplying systems. More particularly, the invention relates to a system whereby water related residential and industrial/commercial facility or building damages associated with water leakage may be reduced or eliminated by selectively disrupting the flow of water into the residence or commercial facility or building when said residence or commercial facility or building is vacated or unsupervised.

### BACKGROUND OF THE INVENTION

Losses to residential property and industrial/commercial facilities owners incident damages caused by broken water pipes are staggering. In part because broken water pipes often go undetected in the absence of the property owner or while the property owner sleeps through the night, water damage from a broken water pipe can be catastrophic. In fact, some insurance agencies report that up to seventy percent of their insurance losses are water related.

Water damages incur billions of dollars of structural, operational, reputational and financial losses each year for residential and commercial property owners. Water damage is the number one source of property claims for owners of high-rise residences, hotels, office buildings, retail establishments and other commercial structures. Leakages can create problems for property owners and managers at any time of year and during any point in a facility's life cycle. What often starts out as a small, undetected leak can quickly spread down through a building, travelling the route of least resistance and at a great distance from its original source, making detection extremely difficult.

It is therefore an object of the present invention to providing a system whereby residential property owners or a industrial/commercial owners may easily protect themselves against catastrophic damages caused by broken water pipes.

Additionally, it is an object of the present invention to provide such a system that may be operated manually or automatically.

Accordingly, a need remains for a water damage prevention system that has a convenient and means facilitates a means to activate and/or deactivate the water flow from the main water supply with a high percentage of use when a residential home or industrial/commercial facility or building is vacated or unsupervised.

### SUMMARY OF THE INVENTION

The present invention is a water damage prevention system that has a residential or industrial/commercial facilities water supply interruption system. The system is comprised of a remotely controllable base station with shut-off/on mechanism that is in a wireless or wired communication with a convenient remotely controller. The remotely controllable base station with shut-off/on mechanism is interposed within a water line from a water main to the living or operating quarters portion of a residential or a industrial/commercial facility or building, such that activation of the base station with shut-off/on valve operates to prevent flow of water from the water main to the living quarters when the residential home or industrial/commercial facility or building is vacated or unsupervised. In this manner, damage to the living quarters or the industrial/commercial facility or building from failure of water pipes running through the living or working quarters is prevented during times that the shut-off mechanism is activated.

To easily and conveniently activate the remotely controllable base station with shut-off/on mechanism, the remote controller preferably comprises a wireless key chain, or a wireless or wired keyboard, or a wireless or wired apparatus that is incorporated within an alarm system or a garage opening system. The remote controller is in wireless or wired communication with water base station with shut-off/on mechanism and the remote controller will have a display means to allow an individual to observe the arrangement of the shut-off/on mechanism. In this manner, occupants or owners may simply press a button on the key chain, or the keyboard, or active a alarm system, or just open and close the garage door of residential home or an industrial/commercial facility or building, causing the flow of water into the living or operating quarters to be interrupted. In a further extension of the present invention, the remote controller may also be provided with a programming timing circuit for automatically operating the base station with shut-off/on mechanism according to a defined schedule. In this embodiment, the timer may automatically cause disruption of water flow into the residential home or industrial/commercial facility or building at times that occupants or workers are normally expected to be absent, vacated, unsupervised. It is anticipated by the Applicants that the disruption of water could be activated during the night or times of resting. It is also anticipated by the Applicants that the base station with shut-off/on mechanism can be provided with an override manual valve which is operable for emergency situations.

It is preferred that the base station with shut-off/on mechanism be battery operated are re-chargeable and could include an electricity generation means such as a water turbine generation, solar cell, or wind generation means. It is also preferred that the key chain remote controller is powered by a battery source. The embodiments where the keyboard, alarm system or garage opener can be a combination of battery and AC/DC current power source.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

FIG. 1 is a perspective view of the embodiment comprising a home with the base station with shut-off/on mechanism is interposed within the main water supply system and communicating wirelessly with a key chain apparatus held in the hand of an individual. The shut-off/on mechanism is shown having a solar panel and a wind power generator connected to the mechanism to supply additional electrical power.

FIG. 2 is a perspective view of the remote controller comprising a key chain apparatus.

FIG. 3 is a perspective view of the remote controller comprising a garage opener that is part of and communicates with the garage opening system.

FIG. 4 is a perspective view of a typical garage opening system used in residential homes.

FIG. 5 is a perspective view of a keyboard/alarm system that incorporates a means to activate and deactivate the base station with shut-off/on mechanism.

FIG. 6 is a perspective more detailed view of the base station with water shut-off/on mechanism and water supply plumbing with optional water turbine generator and is location within the water supply line.

FIG. 7 is an electrical schematic showing the main power, CPU or microprocessor, the analog or digital display means, the clock circuit, the temperature sensor and the flow sensor.

Corresponding reference characters indicate corresponding parts throughout the several views. The exemplifications set out herein illustrate exemplary embodiments of the invention, and such exemplifications are not to be construed as limiting the scope of the invention in any manner.

### DESCRIPTION OF THE PREFERRED EMBODIMENTS

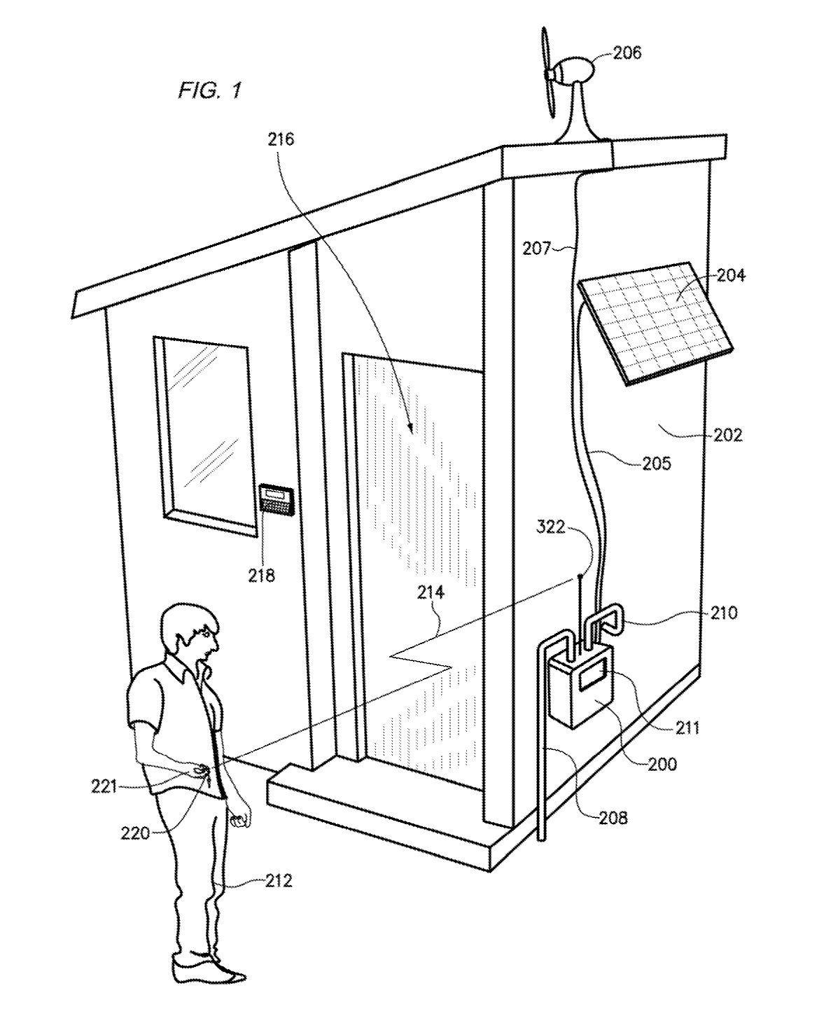

Referring now to the drawings and particularly to FIG. 1, the water damage prevention system 200 of the present invention is shown to generally comprise a remotely controllable base station 200 with water shut-off/on mechanism 310 strategically located between a main supply line 208 from a water main and a household water supply line 210 to a residential building 202. The remotely controllable base station with water shut-off/on mechanism is activated and deactivated by a remote controller 220 to selectively turn on and off the water through the household water supply line 210. In the preferred embodiment of the present invention, the remotely controllable base station 200 with water shut-off/on mechanism 310 is located with respect to the household water supply line 208 such that water flow through the household water supply line 210 to the living quarters of the residential building 202 may be prevented while still allowing water flow to non-residential areas, such as to sprinkler lines. It is also anticipated by the Applicants that the remotely controllable base station 200 with water shut-off/on mechanism 310 can take the place of, and function as, the pressure reduction valve. FIG. 1 also shows the base station 200 with water shut-off/on mechanism 310 connected with a wired means 205 from a solar electrical generation 204 and/or connected with a wired means 207 from a wind electrical generation 206. An antenna 322 is shown extending from the remotely controllable base station with water shut-off/on mechanism.

The housing for the remotely controllable base station 200 (with water shut-off/on mechanism 310) can be fabricated from a metallic material such as metallic alloys, steel, galvanized steel, aluminum or any combination thereof. The housing for the remotely controllable base station 200 (with water shut-off/on mechanism 310) can be fabricated can be also fabricated from a number of polymeric materials, such as polyvinyl chloride (PVC), polyethylene, polybutylene, acryaontirile-butadiene-styrene (ABS), rubber modified styrene, polypropylene, polyacetal, polyethylene, or nylon. The base material can be painted white or colored finishes or coated with various brass, silver and gold type materials to accommodate the match with various presently marketed finishes.

The joint between the water supply lines 208 and 210 and the remotely controllable base station 200 with water shut-off/on mechanism 310 could be screw and thread fitting, compression fitting, flare fitting, solder, brazed, or sweat joint, adhesive technology and/or use typical plumbing techniques. The joint may be designed to be permanent or removable.

The remotely controllable base station 200 with water shut-off/on mechanism 310 can include a display means 211 for displaying various information, such as if the water is interrupted or allowed to flow into the residence or industrial/commercial facility or building, or to help program the software for scheduled water interruption times (off from 8:30 a.m. until 4:30 p.m. then on, off again at 11:00 p.m. until 5:00 a.m. and then on again). The display means 211 can help program the software to display calendar information, such as the date and current time (12 hr. or 24 hr. format). In this regard, the controllable base station 200 can be programmed using a wire or wireless remote keyboard, alarm system, or use touch screen button technology on the display. The display utilizes one or more illuminating technologies, such as LCD, LED, gas plasma, fluorescence, incandescent, halogen, halide, or other lighting technologies but must able to provide sufficient lighting for observing the data in shower conditions. In addition, the display means and display means housing must be able to sustain capability in outdoor wet and/or hot conditions. The display 211 can have a background light that is used for various purposes, for example, for providing better lighting conditions or changing color e.g. from green to red, to display an alarming condition. An example of a LCD unit that can be used with the present invention is the color graphic 128×128 LCD-00569 marketed by Sparkfun Electronics in Boulder, Colo. It is anticipated by the Applicants that there are other variants and other LCD, LED, gas plasma, fluorescence, incandescent, halogen, halide, or other lighting technologies that can be utilized with the present invention. The display can utilize touch screen technology.

One of the key features of the present invention water damage prevention system is that it has a convenient and easy means which facilitates activation and/or deactivation of the water flow from the main water supply with a high percentage of use when a residential home or industrial/commercial facility or building becomes vacated or unsupervised. If a non-convenient means is utilized, the ratio of use will decrease which compromises the design goal of the present invention. In this regard, shown in FIG. 1 is an individual 212 holding a remote wireless key chain apparatus 220 in his hand 221. Generally one carries one or more key chains for holding keys for entry of one's residence or office, car operation etc. The remote wireless key chain apparatus 220 communicates wirelessly with the remotely controllable base station 200 with water shut-off/on mechanism 310 with a wireless means 214. Another embodiment of the present invention show a programmable alarm keyboard 218 as part of an overall residential or commercial alarm system.

The wireless means 214 can use radio-frequency, Bluetooth, WiFi, Zigbee, optical or other wireless technology for communicating with the remotely controllable water shut-off/on mechanism 200. Examples of Bluetooth modules (using the 2.4 GHz band as WiFi) that can be added to the present invention are the RN-41 Bluetooth modules available from Roving Networks in Los Gatos, Calif., the KC-41, KC 11.4, KC-5100, KC-216 or KC-225 data serial modules from KC Wireless in Tempe Ariz., and/or the BT-21 module from Amp'ed RF wireless solutions in San Jose, Calif. Examples of wireless protocols that can be utilized with the present invention include, but are not limited to, the IEEE 802.11a, IEEE 802.11b, IEEE 802.11g and IEEE 802.11n modulation techniques. Applicants recognize that there are numerous wireless protocols that have been developed that, although not specifically listed, could be utilized with the present invention for data transfer purposes.

ISM bands defined by the ITU-R are:

| | | Center | | |
|---|---|---|---|---|
| Frequency range [Hz] | | frequency [Hz] | | Availability |
| 6.765-6.795 | MHz | 6.780 | MHz | Subject to local acceptance |
| 13.553-13.567 | MHz | 13.560 | MHz | |
| 26.957-27.283 | MHz | 27.120 | MHz | |
| 40.66-40.70 | MHz | 40.68 | MHz | |
| 433.05-434.79 | MHz | 433.92 | MHz | Region 1 only |
| 902-928 | MHz | 915 | MHz | Region 2 only |
| 2.400-2.500 | GHz | 2.450 | GHz | |
| 5.725-5.875 | GHz | 5.800 | GHz | |
| 24-24.25 | GHz | 24.125 | GHz | |
| 61-61.5 | GHz | 61.25 | GHz | Subject to local acceptance |
| 122-123 | GHz | 122.5 | GHz | Subject to local acceptance |
| 244-246 | GHz | 245 | GHz | Subject to local acceptance |

While currently the 430 MHz and 900 MHz frequencies are commonly used in the US, it is anticipated by the Applicants that the other frequencies could be used for signal and data transfers.

Another protocol known as CAN or CAN-bus (ISO 11898-1) was originally designed for automotive applications, but is now used in industrial applications. CAN is another type of network that can be used to transfer water parameter data. Devices that are connected by a CAN network are typically sensors, actuators and control devices. A CAN message never reaches these devices directly, but instead a host-processor and a CAN Controller is used between these devices and the bus.

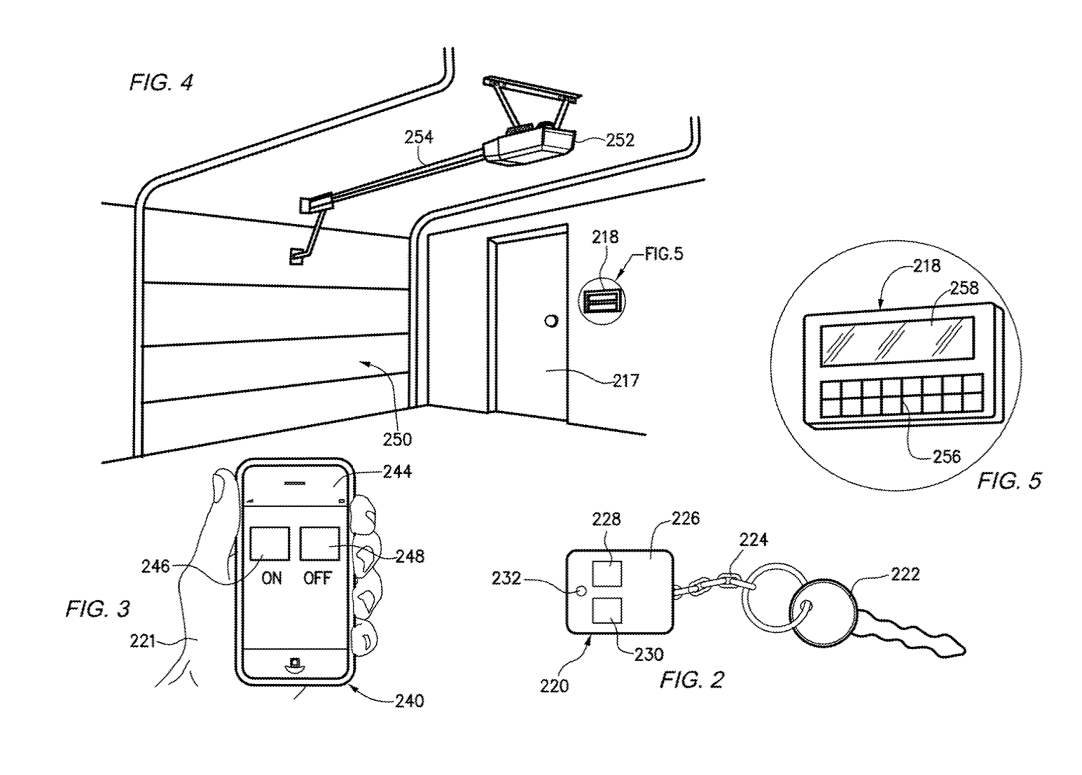

Now referring to FIG. 2 which is a perspective view of the remote controller comprising a key chain apparatus 220. The remote controller key chain apparatus 220 is of a convenient size for placing in a pocket or purse and has a chain connection 224 for attached one or more keys 222. The main housing 226 of the key apparatus 220 has a pair of buttons. One button 228 activates the base station 200 with water shut-off/on mechanism 310 through wireless communication 114 interrupting or activates the water supply to the residence 216 or industrial/commercial building. The other button 230 deactivates the base station water 200 with shut-off/on mechanism 310 to turn on the water supply. It is anticipated by the Applicants that one button can be utilized to activate and deactivate means (toggle on and off). An indicator light (or display) can show the state of the shut-off/on mechanism, e.g. green for open (deactivated) and red for closed (activated). In addition, an auditory alarm can be incorporated into the present invention for the purposes of relating the state of the shut-off/on mechanism e.g. one beep for on and two beeps for off. The remote controller key chain apparatus 220 also has, but is not shown, an internal replaceable or rechargeable battery with an operable battery door, electrical circuitry, and transceiver with internal antenna. The wireless communication means 114 will preferably utilize encryption, authentic, integrity and/or non-repudiate techniques to provide a secure signal so that the activation or deactivation occurs with integrity and accuracy such that that is not conflict with other wireless signals or technology in the immediate area. Also, with residences and industrial/commercial buildings in close proximity, it is essential that the signal only activates or deactivates the intended and specific base station 200 with water shut-off/on mechanism 310. Such technology will ensure that the signal is secure such that unintended or intended signals do not send control messages to non-desired or non-owned base stations 200 with water shut-off/on mechanisms 310.

FIG. 3 shows a garage door opener 240 that is part of an overall garage door 250 opening system 252 with chain or cable driving mechanism 254. The garage door opener is typical in size and function with a button 244 for opening and closing the garage door. The difference is that the garage door opener has additional buttons. One button 228 activates the base station water 200 with shut-off/on mechanism 310 through wireless communication 114, interrupting the water supply to the residence 216 or industrial/commercial building. The other button 230 deactivates the base station 200 with water shut-off/on mechanism 310 to turn on the water supply. It is anticipated by the Applicants that one button can be utilized to activate and deactivate means (toggle on and off). An indicator light (or display) can show the state of the shut-off/on mechanism, e.g. green for open and red for closed. In addition, an auditory alarm can be incorporated into the present invention for the purposes of relating the state of the shut-off/on mechanism. It is anticipated that new garage door opening systems 252 can incorporate the components necessary to communicate wirelessly or hard wired to communicate with the base station 200 with water shut-off/on mechanism 310 of the water damage prevention system. In previously installed garage door opening systems, a specifically designed electrical module can be electrically attached to the previously install garage door opening system that works with a new garage door opener 240. The wireless communication means will preferably utilize encryption, authentic, integrity and/or non-repudiate techniques to provide a secure signal so that the activation or deactivation occurs with integrity and accuracy such that that is not conflict with other wireless signals or technology in the immediate area. Also, with residences and industrial/commercial buildings in close proximity, it is essential that the signal only activates or deactivates the intended and specific base station 200 with water shut-off/on mechanism 310. Such technology will ensure that the signal is secure such that unintended or intended signals do not send control messages to non-desired or non-owned base stations 200 with water shut-off/on mechanisms 310.

FIG. 4 is a perspective view of a typical garage opening system. The typical garage door opening system has a distal means to attached to the garage door 250 the engages a chain, belt or screw drive mechanism 254 that is operated by a proximal housing 252 that contains an electric motor, lights, timing circuits, and wireless communication technology. Near the garage door shown is an alarm keypad 218 as discussed in more detail in the paragraph below.

FIG. 5 shows an alarm keyboard 218 that is part of an overall alarm system. One or more alarm keyboards 218 are typically located within the living quarters of the residential or commercial building adjacent an entry doorway. In this embodiment, specific coding of the alarm system will be necessary. By pushing specific keys on the keyboard (hard or soft keys) 256 will be utilized to not only input alarm codes, but also to activate and deactivate the base station 200 with water shut-off/on means 310. In one operation, when one arms the alarm system, after the delay, the alarm system will become activated and the alarm system can communicate wirelessly or by hard wired with the base station 200 with water shut-off/on mechanism 310. In another operation, a specific step, key code or question will be necessary in the alarm programming to include an intended response before the corresponding wireless or hard wired signal is sent to the base station 200 with water shut-off/on mechanism 310. This may be a necessary step as some individuals use the alarm system (peripheral surveillance) when they are in their homes for additional protection. It is anticipated that new alarm systems can incorporate the software instruction and components necessary to communicate wirelessly or hard wired to communicate with the base station 200 with water shut-off/on mechanism 310 of the water damage prevention system. In previously installed alarm systems, a specifically designed electrical module may be electrically attached to the previously install alarm system. The wireless communication means will preferably utilize encryption, authentic, integrity and/or non-repudiate techniques to provide a secure signal so that the activation or deactivation occurs with integrity and accuracy such that that is not conflict with other wireless signals or technology in the immediate area. Also, with residences and industrial/commercial buildings in close proximity, it is essential that the signal only activates or deactivates the intended and specific base station with water shut-off/on mechanism. Such technology will ensure that the signal is secure such that unintended or intended signals do not send control messages to non-desired or non-owned base stations 200 with water shut-off/on mechanisms 310.

An option to be utilized with the present invention is that the base station 200 with water shut-off/on mechanism 310 can include programming instructions with a timing circuit to a user defined time schedule. In this manner, the residential occupant or industrial/commercial owner may simply establish that the water supply will be blocked during working hours and/or during sleeping hours. The scheduling could be a daily, weekly, monthly or annual. The programming of the timing schedule could be input into the CPU of the base station electrical circuitry via various methods, e.g. wireless or wired communication with a computer with appropriate software, using the remote controllers, or using touch screen technology on the display means, etc.

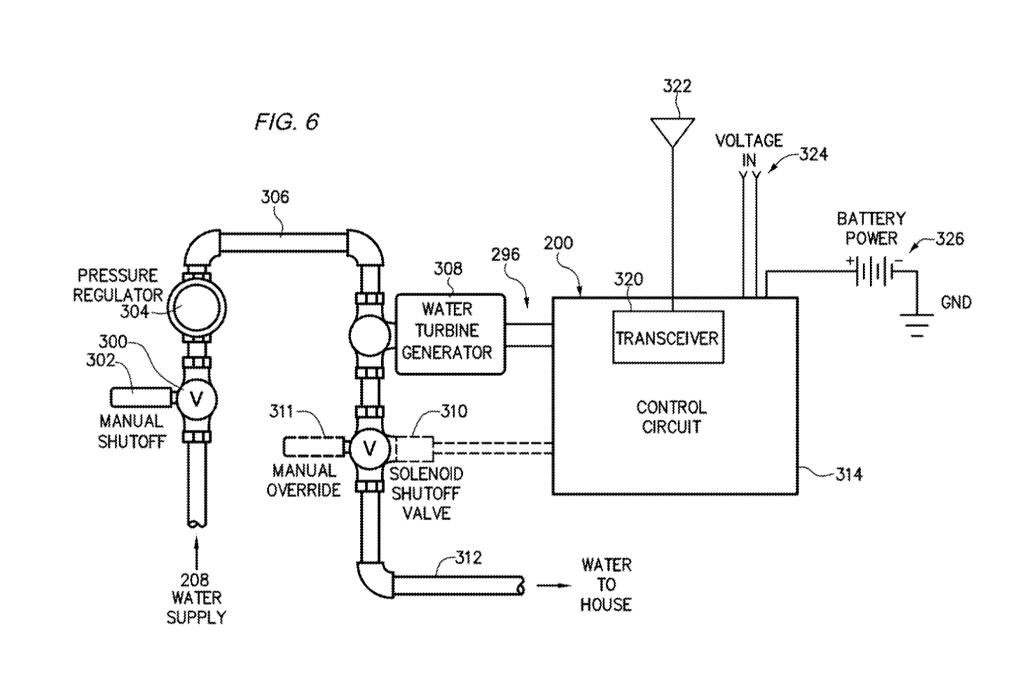

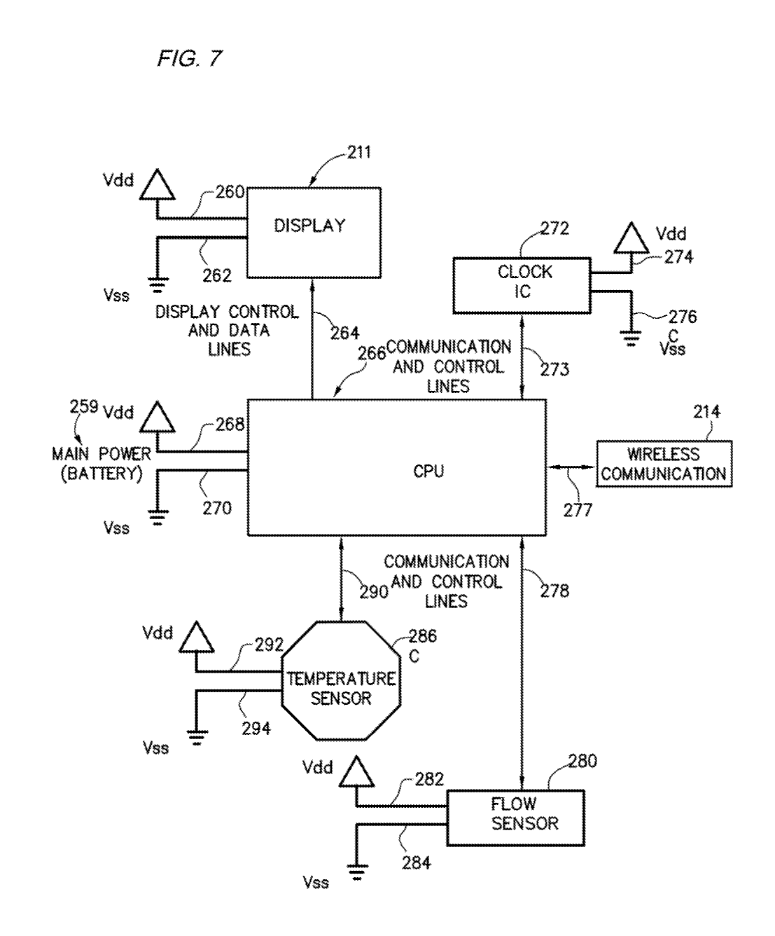

Now referring to FIG. 6, shown is a perspective more detailed view of the base station 200 with water shut-off/on mechanism 310 and water supply plumbing, and with optional water turbine generator 508 that is located within the water supply line. The water supply line from the water main 208 first engages a manual shut off valve 302. The manual shut off valve can be a ball valve, gate value type, piston valve, or other known technology. Further along the water supply line is a pressure regulator 304 with a connecting pipe 306 to the present invention water damage prevention system base station 200 with water shut-off/on mechanism 310. Also shown is an optional water turbine generator 308 that could be utilized to produce electrical energy for recharging the battery source 326. The water shut-off/on mechanism 310 (shown as solenoid shutoff valve) can be a ball valve, gate value type, piston valve, or other known technology with electronic activation. A mechanical lever 311 can be incorporated on the water shut-off/on mechanism (solenoid shutoff valve) to allow the modification of the mechanism to open the water flow in emergency and necessary situations. The base station 200 has a transceiver 320 that includes an antenna 322 which can be external or internal. The control circuit for the base station 200, shown in more detail in FIG. 7, includes programmable CPU, a power source (battery, AC or DC), and electrical circuitry, wireless or hard wired components, and optional sensors and associated circuitry. Also shown is a voltage in 324 which would electronically engage the optional solar cell 302 or wind generator 206 to provide additional electrical energy. It is anticipated by the Applicant's that the water shut-off/on mechanism 311 (solenoid shutoff valve), and if used, the optional water turbine generator 308, could be incorporated within the base station 200 as a single unit. It is also anticipated that the base station 200 with water shut-off/on valve 310 could replace, and function as, the pressure regulator, eliminating one of the components shown in this drawing. Exiting from the base station 200 with water shut-off/on mechanism 310 is the main water supply 312 to the home (or commercial facility or building).

Shown in FIG. 7 is a more detailed description of the electrical circuitry. A timing clock integrated circuit 272 with data transfer means 273 for communicating with the CPU or microprocessor 266 and having a power line 274 and ground line 276. The timing sensor can communicate with the CPU or microprocessor to display such information such as the time of day and current date and/or the totally duration that the water supply has been on before it was turned off, or for providing scheduling procedures. Various mechanical and magnetic switches can be utilized to communicate a signal to the CPU or microprocessor 84 that water supply has been turned off and on.

The wireless communication means 214 communicates with the programmable CPU 266 through data lines 277. The programmable CPU or microprocessor 266 receives electrical energy through power line 268 and a ground line 270. The optional display 211 communicates with the CPU or microprocessor 266 with display control and data lines 264. If utilized, the display 211 receives electrical energy through power line 260 and a ground line 262.

An optional temperature sensor 286 can be incorporated in the base station 200 to monitor water temperature. The temperature sensor 286 can be used to sense freezing conditions which might disrupt proper operation of the system, or can be utilized to provide more accuracy of other components, such as the flow sensor. The optional temperature sensor 286 receives electrical energy through power line 292 and a ground line 294.

An optional flow sensor 280 can be incorporated in the base station 200 to monitor water flow. The flow sensor 280 can be used to send the signal through the CPU/microprocessor to the remote controllers 218, 220 and 244 for confirmation that the water flow has been interrupted. While the position of the shut-off/on mechanism valve 310 can also be used for this purpose, for additional confirmation that the water flow has been interrupted. The optional flown sensor 280 receives electrical energy through power line 282 and a ground line 284

The CPU or microprocessor 266 that processes the control signals supplied by the remote controllers 218, 220 and 244, the timing circuitry 272, and the optional temperature 286 and flow sensors 280 uses internal instructions to control the information projected on the remote controllers 218, 220 and 244 and optional display 211. The microprocessor can include an EEPROM or any type of memory section that allows for specific programming to be incorporated as processing instructions (e.g. scheduling). Furthermore, the microprocessor may have the capability to convert analog signals into digital information for decoding and processing. An example of a CPU or microprocessor 266 that could be used for the CPU or microprocessor is the PIC16F876 28-pin 8-Bin CMOS FLASH micro-controllers manufactured by Microchip Technology, Inc. This particular microprocessor has a 128K EEPROM Data memory bank for flash memory of specific instructions and utilizes a 35-word instruction set. It also has five 10-bit Analog-to-Digital Inputs that can provide the means for converting the information obtained from the optional temperature sensor 286 and flow sensor 280 from analog format into a digitized form for processing by the instruction sets of the CPU or microprocessor 266. Another example of a microprocessor that could be used for the CPU or microprocessor 266 is the MSP430 family of processors from Texas Instruments in Dallas, Tex. There are hundreds of variants but for an example, the MSP430F436IPN (80 pin package) or MSP430F436IPZ (100 pin package) could be utilized in the present invention. There are many other variants or other microprocessors, whether commercially marketed or privately fabricated, that can be used with the present invention.

While this invention has been described as having a preferred design, the present invention can be further modified within the spirit and scope of this disclosure. The application is therefore intended to cover any variations, uses, or adaptations of the invention using its general principles. Further, this application is intended to cover such departures from the present disclosure that arise from known or customary practice and the art to which this invention pertains and which fall within the limits of the appended claims.

1. A residential or industrial/commercial water damage prevention system, said system comprising: a remotely controllable base station with a water shut-off/on mechanism interposed between a water line from a water main and a water supply for a residential or industrial/commercial facility or building, said base station with a water shut-off/on mechanism being adapted to selectively prevent flow of water through said water supply to said residential home or industrial/commercial facility or building, the improvement comprising a wireless key chain apparatus in wireless communication with said remotely controllable base station with shut-off/on mechanism, said key chain apparatus designed to send a wireless signal to said base station to turn said water supply on and off, said key chain apparatus having an indicating means for determining the operational state of the shut-off/on mechanism.

2. A residential or industrial/commercial water damage prevention system as recited in claim 1, wherein said base station with remotely controllable base station with shut-off/on mechanism is interposed between the water supply line for a sprinkler system and the water line for a household or industrial/commercial building, such that such that operation of said sprinkler system is not interrupted by the activation of the base station with shut-off/on mechanism.

3. A residential or industrial/commercial water damage prevention system as recited in claim 1, wherein said water base station with shut-off/on mechanism further comprises a programmable time circuitry, said time circuitry being adapted to actuate the shut-off/on mechanism for a programmable determined time.

4. A residential or industrial/commercial water damage prevention system as recited in claim 1, further comprising a mechanical adaptor that enables an override to allow water flow when the base station with shut-off/on mechanism is activated.

5. A residential or industrial/commercial water damage prevention system as recited in claim 1, wherein said shut-off/on mechanism within said base station is powered by a battery source.

6. A residential or industrial/commercial water damage prevention system as recited in claim 5, further comprising a water turbine generator, solar cell and/or wind generation system to provide supplemental electrical energy to said battery source.

7. A residential or industrial/commercial water damage prevention system as recited in claim 1, wherein said base station with shut-off/on mechanism replaces and functions as the pressure regulator.

8. A residential or industrial/commercial water damage prevention system, said system comprising: a remotely controllable base station with a water shut-off/on mechanism interposed between a water line from a water main and a water supply for a residential or industrial/commercial facility or building, said base station with a water shut-off/on mechanism being adapted to selectively prevent flow of water through said water supply to said residential home or industrial/commercial facility or building, the improvement comprising a garage opener apparatus incorporated with a garage opening system in wireless or wired communication with said remotely controllable base station with shut-off/on mechanism, said garage opener apparatus designed to send a wireless and/or hard wired signal to said base station to turn said water supply on and off, said garage opener apparatus having an indicating means for determining the operational state of the shut-off/on mechanism.

9. A residential or industrial/commercial water damage prevention system as recited in claim 8, wherein said base station with remotely controllable base station with shut-off/on mechanism is interposed between the water supply line for a sprinkler system and the water line for a household or industrial/commercial building, such that such that operation of said sprinkler system is not interrupted by the activation of the base station with shut-off/on mechanism.

10. A residential or industrial/commercial water damage prevention system as recited in claim 8, wherein said water base station with shut-off/on mechanism further comprises a programmable time circuitry, said time circuitry being adapted to actuate the shut-off/on mechanism for a programmable determined time.

11. A residential or industrial/commercial water damage prevention system as recited in claim 8, further comprising a mechanical adaptor that enables an override to allow water flow when the base station with shut-off/on mechanism is activated.

12. A residential or industrial/commercial water damage prevention system as recited in claim 8, wherein said shut-off/on mechanism within said base station is powered by a battery source.

13. A residential or industrial/commercial water damage prevention system as recited in claim 12, further comprising a water turbine generator, solar cell and/or wind generation system to provide supplemental electrical energy to said battery source.

14. A residential or industrial/commercial water damage prevention system as recited in claim 8, wherein said base station with shut-off/on mechanism replaces and functions as the pressure regulator.

15. A residential or industrial/commercial water damage prevention system, said system comprising: a remotely controllable base station with a water shut-off/on mechanism interposed between a water line from a water main and water supply for a residential or industrial/commercial facility or building, said base station with a water shut-off/on mechanism being adapted to selectively prevent flow of water through said water supply to said residential home or industrial/commercial facility or building, the improvement comprising a keyboard/alarm apparatus incorporated with a alarm system in wireless or wired communication with said remotely controllable base station with shut-off/on mechanism, said keyboard/alarm apparatus designed to send a wireless and/or hard wired signal to said base station to turn said water supply on and off, said garage opener apparatus having an indicating means for determining the operational state of the shut-off/on mechanism.

16. A residential or industrial/commercial water damage prevention system as recited in claim 15, wherein said base station with remotely controllable base station with shut-off/on mechanism is interposed between the water supply line for a sprinkler system and the water line for a household or industrial/commercial building, such that such that operation of said sprinkler system is not interrupted by the activation of the base station with shut-off/on mechanism.

17. A residential or industrial/commercial water damage prevention system as recited in claim 15, wherein said water base station with shut-off/on mechanism further comprises a programmable time circuitry, said time circuitry being adapted to actuate the shut-off/on mechanism for a programmable determined time.

18. A residential or industrial/commercial water damage prevention system as recited in claim 15, further comprising a mechanical adaptor that enables an override to allow water flow when the base station with shut-off/on mechanism is activated.

19. A residential or industrial/commercial water damage prevention system as recited in claim 15, wherein said shut-off/on mechanism within said base station is powered by a battery source.

20. A residential or industrial/commercial water damage prevention system as recited in claim 19, further comprising a water turbine generator, solar cell and/or wind generation system to provide supplemental electrical energy to said battery source.

21. A residential or industrial/commercial water damage prevention system as recited in claim 15, wherein said base station with shut-off/on mechanism replaces and functions as the pressure regulator.

22. A residential or industrial/commercial water damage prevention system as recited in claim 15, wherein said base station with shut-off/on mechanism can be programmed to follow a specific schedule for interrupting the water flow or allowing the water flow into the home or commercial building or facility.

23. A residential or industrial/commercial water damage prevention system as recited in claim 8, wherein said base station with shut-off/on mechanism can be programmed to follow a specific schedule for interrupting the water flow or allowing the water flow into the home or commercial building or facility.

24. A residential or industrial/commercial water damage prevention system as recited in claim 15, wherein said base station with shut-off/on mechanism can be programmed to follow a specific schedule for interrupting the water flow or allowing the water flow into the home or commercial building or facility.
